(19) United States
(12) Patent Application Publication
(10) Pub. No.: US 2017/0003765 A1
(43) Pub. Date: Jan. 5, 2017

(54) AUTOMATIC ORIENTATION OF A DEVICE

(71) Applicant: Apple Inc., Cupertino, CA (US)

(72) Inventors: Anna-Katrina Shedletsky, Cupertino, CA (US); Erik D. de Jong, Cupertino, CA (US); Fletcher R. Rothkopf, Cupertino, CA (US); Samuel B. Weiss, Cupertino, CA (US)

(21) Appl. No.: 15/114,860

(22) PCT Filed: Jan. 31, 2014
(86) PCT No.: PCT/US2014/014254

§ 371 Date: Jul. 28, 2016

(51) Int. Cl. G06F 3/0346; G06F 1/16; G06F 3/16; G06F 3/0488; G06F 3/041; G06F 1/32; G06F 3/01

(52) U.S. Cl. CPC G06F 3/0346; G06F 1/3231; G06F 1/163; G06F 3/015; G06F 3/04883; G06F 3/0414; G06F 3/167; G06F 2200/1614; G06F 3/0304

(57) ABSTRACT

One or more embodiments of the present disclosure provide a system and method for presenting a user interface on a wearable electronic device. In certain embodiments, input is received from at least one sensor coupled to the wearable electronic device. Once the input from the at least one sensor is received, an orientation of the wearable electronic device is determined with respect to an object to which the wearable electronic device is attached. When the orientation of the wearable electronic device is determined, a user interface is presented on a display of the wearable electronic device. In embodiments, the user interface is displayed in an orientation that is based, at least in part, on the determined orientation of the wearable electronic device.

### TECHNICAL FIELD

The present disclosure is directed to a user interface on an electronic device. Specifically, the present disclosure is directed to displaying a user interface on a wearable electronic device based on a determined orientation of the electronic device.

### BACKGROUND

Typically, electronic devices include a display that is used to show a graphical user interface. In some instances, the graphical user interface may display various types of information. Additionally, a user interface may be used to receive user input. However, as the electronic device is moved from a first position to a second position, the user interface on the device may not be displayed correctly.

It is with respect to these and other general considerations that embodiments have been made. Also, although relatively specific problems have been discussed, it should be understood that the embodiments should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

One or more embodiments of the present disclosure provide a system and method for presenting a user interface on a wearable electronic device. In certain embodiments, input is received from at least one sensor coupled to the wearable electronic device. Once the input from the at least one sensor is received, an orientation of the wearable electronic device is determined with respect to an object to which the wearable electronic device is attached. When the orientation of the wearable electronic device is determined, a user interface is presented on a display of the wearable electronic device. In embodiments, the user interface is displayed in an orientation that is based, at least in part, on the determined orientation of the wearable electronic device.

In another embodiment of the present disclosure a method and system is provided for presenting a user interface on a wearable electronic device. In such embodiments, input is received from at least one sensor coupled to the wearable electronic device. Based on the input, a determination is made as to whether a display of the wearable electronic device is in a field of view of an individual wearing the wearable electronic device. When it is determined that the display of the wearable electronic device is not in a field of view of the individual wearing the wearable electronic device, a display of the wearable electronic device is configured to enter a standby mode. Additionally, when it is determined that the display of the wearable electronic device is in a field of the view of the individual wearing the wearable electronic device, one or more embodiments provide that a determination of an orientation of the wearable electronic device is made. In such embodiments, this determination is made based on input received from at least one sensor. Once the orientation of the wearable electronic device is determined, a user interface is displayed on the display of the wearable electronic device. In embodiments, the user interface is displayed in a first orientation that is based, at least in part, on the determined orientation of the wearable electronic device.

### BRIEF DESCRIPTION OF THE DRAWINGS

FIG. 1 illustrates an exemplary wearable electronic device according to one or more embodiments of the present disclosure;

FIG. 2 illustrates a wearable electronic device being worn by an individual according to one or more embodiments of the present disclosure;

FIG. 3 illustrates a wearable electronic device in which a view of a user interface of the wearable electronic device is partially occluded according to one or more embodiments of the present disclosure;

FIG. 4 illustrates a method of presenting a user interface on a display of a wearable electronic device based on a determined orientation of the wearable electronic device according to one or more embodiments of the present disclosure;

FIG. 5 illustrates a method for presenting a user interface on a display of wearable electronic device according to one or more embodiments of the present disclosure;

FIGS. 6A and 6B illustrate a wearable electronic device configured to change its position along a wearable band according to one or more embodiments of the present disclosure;

FIG. 7 illustrates a retention mechanism of a wearable electronic device according to one or more embodiments of the present disclosure;

FIG. 8 illustrates a pivot mechanism configured to rotate a display of a wearable electronic device according to one or more embodiments of the present disclosure;

FIG. 9 illustrates a method for changing a position of a wearable electronic device along a wearable band according to one or more embodiments of the present disclosure;

FIG. 10 is a block diagram illustrating example physical components of a wearable electronic device that may be used with one or more embodiments of the present disclosure; and

FIG. 11 is simplified block diagrams of a wearable computing device that may be used with one or more embodiments of the present disclosure.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. The following detailed description is, therefore, not to be taken in a limiting sense.

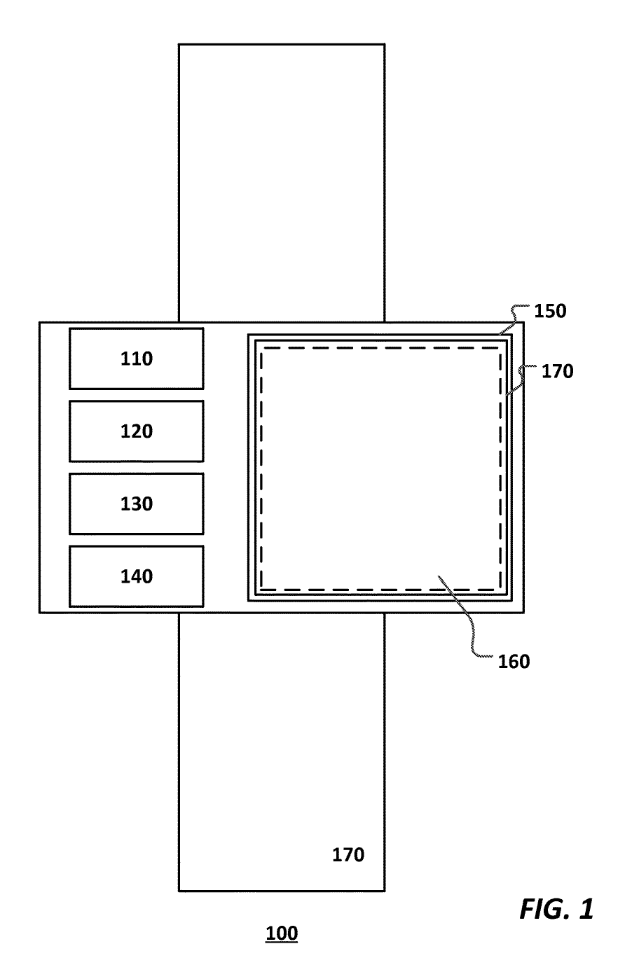

FIG. 1 illustrates an exemplary wearable electronic device 100 according to one or more embodiments of the present disclosure. In certain embodiments, the wearable electronic device 100 may be a computing device. Such examples include cell phones, smart phones, tablet computers, laptop computers, time keeping devices, glasses, navigation devices, sports devices, accessory devices, health devices, medical devices and the like. As shown in FIG. 1, the wearable electronic device 100 may include a sensor 110, a microphone 120, a processor 130 and a memory 140. The wearable electronic device 100 may also include a band 170 which may be removably or slideably coupled to the wearable electronic device 100. Additionally, the band 170 may be used by an individual to wear the wearable electronic device 100.

Although specific components are mentioned and displayed, it is contemplated that additional components may be present in the wearable electronic device 100. For example, the wearable electronic device 100 may include a keyboard or other input mechanism. Additionally, the wearable electronic device 100 may include one or more components that enable the wearable electronic device 100 to connect to the internet and/or access one or more remote databases or storage devices. The wearable electronic device 100 may also enable communication over wireless media such as acoustic, radio frequency (RF), infrared, and other wireless media mediums. Such communication channels may enable the wearable electronic device 100 to remotely connect and communicate with one or more additional devices such as, for example, a laptop computer, tablet computer, mobile telephone, personal digital assistant, portable music player, speakers and/or headphones and the like.

One or more embodiments provide that the wearable electronic device 100 also includes a display 150 with an input area 160. The input area 160 may cover the entire display 150 or substantially all of the display 150. In another embodiment, the input area 160 may cover only a portion of the display 150.

In embodiments, the display 150 is configured to display a user interface 170. The user interface 170 displays information about the wearable electronic device 100 as well as other information stored in a memory 140 of the wearable electronic device 100. The user interface 170 may present information corresponding to one or more applications that are being executed on the wearable electronic device 100. Such applications may include an email application, phone application, calendaring application, game application and the like.

In certain embodiments, the memory may also be configured to store settings and/or orientation information received from the sensor 110 or microphone 120. For example, if the sensor 110 determines an orientation that the user interface is to be rendered in based on a determination of the orientation of the wearable electronic device 100, the memory 140 may be configured to store the orientation information. As a result, when the wearable electronic device 100 is back in that orientation, the user interface may be rendered in the saved orientation.

As discussed above, the wearable electronic device 100 may include a sensor 110. Although only one sensor is shown, it is contemplated that the wearable electronic device 100 may include multiple sensors. In certain embodiments, when multiple sensors are used, each of the sensors may work together to determine a desired orientation of the user interface. This is contemplated even if the sensors are configured to detect different parameters. For example, an accelerometer may work in conjunction with a camera to determine a desired orientation of the user interface 170.

In embodiments, the sensor 110 may be used to determine the location of the wearable electronic device 100 with respect to another object, such as, for example, an individual wearing the wearable electronic device 100. For example, the sensor 110 may be configured to determine whether the wearable electronic device 100 is on a right arm or a left arm of an individual wearing the wearable electronic device 100. Additionally, the sensor 110 may be configured to determine position or orientation of the wearable electronic device 100 with respect to an object. For example, if the wearable electronic device 100 is being worn on an arm of an individual, the sensor 110 may be configured to determine whether the wearable electronic device 100 is positioned on a top side of the wrist of the individual or a bottom side of the wrist of the individual.

In certain embodiments, the sensor 110 may be a force sensor. In such embodiments the sensor 110 may be configured to sense one or more characteristics of the object to which the wearable electronic device 100 is attached. For example, if the wearable electronic device 100 is worn on an arm or wrist of an individual, the sensor 110 may be configured to detect one or more styloids in the wrist of the individual. From that information, the wearable electronic device 100 may be able to determine its orientation (i.e., whether it is positioned on a back side of the wrist or a top side of the wrist) and/or which direction is “away” from an individual wearing the wearable electronic device 100. Using this information, the wearable electronic device 100 may cause that the user interface is rendered in a given orientation (i.e., right side up when viewed by the individual).

In another embodiment, the sensor 110 may be an accelerometer. In such embodiments, the sensor 110 may be used in conjunction with one or more additional sensors (e.g., a gyroscope) to determine an orientation of the wearable electronic device 100. For example, if the wearable electronic device 100 is worn on an arm of an individual, the accelerometer may be configured to determine the period of motion of the wearable electronic device 100 as the individual moves an arm. From this information, the accelerometer may be able to determine an arc associated with the arm movement as well as the direction the arm is moving. From that information, the location of the wearable electronic device 100 with respect to the individual may be determined. Once the location is determined, an orientation of the user interface 170 may be determined.

The sensor 110 may also be a biometric, electrical or electrocardiograph sensor that is configured to determine heart and/or blood measurements of an individual wearing the wearable electronic device 100. For example, the sensor 110 may be configured to sense a pulse of an individual wearing the wearable electronic device 100. Additionally, another sensor may be configured to determine the time delay of blood flow. As a result, the wearable electronic device 100 may be configured to determine which way blood is flowing and thus determine which way is up the arm and toward the head of the individual wearing the wearable electronic device 100 and which way is away from the head of the individual. Using this information, the wearable electronic device 100 may be able to determine its position and orientation on the body of the individual wearing the wearable electronic device 100 and orient the user interface 170 accordingly.

In another embodiment, the sensor 110 may be a capacitive sensor that is configured to detect the capacitive mass of the individual wearing the wearable electronic device 100. In another embodiment, the sensor 110 may be configured to detect thermal readings of an individual wearing the wearable electronic device 110. In such embodiments, the detected thermal readings may be used to determine where on the body the wearable electronic device 100 is located as a temperature of a particular part of the body may be cooler as distance from the core increases. Thus, based on this information, the wearable electronic device 100 may determine it is being worn on an arm of an individual. From that information, the wearable electronic device 100 may be configured to orient the user interface 170 accordingly.

In yet another embodiment, the sensor 110 may be a light sensor. In such embodiments, the light sensor may be configured to determine if a display 140 of the wearable electronic device 100 is occluded or partially occluded, such as, for example, by an article of clothing. If the wearable user interface 170 is occluded or partly occluded, the wearable electronic device 100 may be configured to enter a low power state. In another embodiment, the wearable electronic device 100 may be configured to determine that because the associated user interface 170 is at least partially occluded, it is being worn on an arm of an individual. Additionally, the wearable electronic device 100 may be configured to determine which arm of the individual the wearable electronic device 100 is located based on which side of the wearable electronic device 100 is located. For example, if a left side of the wearable electronic device 100 is at least partially occluded the wearable electronic device 100 may determine that it is being worn on a left arm of the individual. Likewise, the wearable electronic device 100 may be able to determine differing grades of light in given directions (e.g., more light in one direction, such as, for example toward a wrist of an individual wearing the wearable electronic device 100, and less light in a second direction that is different from the first direction, such as, for example, away from a wrist of the individual wearing the wearable electronic device 100).

In still yet another embodiment, the sensor 110 may be an image sensor that is part of a camera (not shown) in the wearable electronic device 100. In such embodiments, the image sensor may be configured to determine whether an individual wearing the wearable electronic device 100 is looking at a display 140 of the wearable electronic device 100. If the individual is looking at the display 140 of the wearable electronic device 100, the sensor 110 may determine based on movement of the eye, the orientation of the eye, etc., of a desired orientation of the user interface 170. In addition, the image sensor may be able to determine an orientation of the wearable electronic device 100 by temporarily analyzing its surroundings and making a determination of its orientation based on the collected data.

One or more embodiments provide that the sensor 110 may be part of the display 140. For example, the display 140 may be touch sensitive display that is configured to determine an angle at which a finger or other input mechanism interacts with the touch sensitive display. Based on that input, the wearable electronic device 100 may be able to determine the direction or angle at which a finger is coming from. Using this information the wearable electronic device 100 may be able to determine a location and/or orientation of the wearable electronic device 100 with respect to an individual wearing the wearable electronic device 100. For example, the sensor may be able to determine a direction the finger is coming from based on a shape of the contact area, capacitance of hand or finger on the touch-sensitive display, fingerprint information and the like.

Referring back to FIG. 1, the wearable electronic device 100 may also include a microphone 120. Although one microphone is shown, it is contemplated that the wearable electronic device 100 may include multiple microphones. In certain embodiments, the microphone 120 may also be used to determine an orientation or position of the wearable electronic device 100 with respect to an individual wearing the wearable electronic device 100. For example, one or more embodiments provide that the microphone could be used to detect the rubbing of an article of clothing against the wearable electronic device 100 to determine whether the wearable electronic device 100 is obscured or partially obscured by the article of clothing. In addition, the microphone 120 may be configured to detect and recognize a voice of an individual (including determining a direction from which the voice originates) wearing the wearable electronic device 100. The microphone 120 may also be configured to interact with other devices such as, for example, ear buds, mobile phone, laptop or tablet computer, and determine a location based of the wearable electronic device 100 with respect to the individual wearing the wearable electronic device 100.

In certain embodiments, the input from sensor 110 and/or the microphone 120 may be received by the processor 130. Based on this input, the processor 130 may be able to determine a position and orientation of the wearable electronic device 100. Based on this information, the processor 130 may be able to determine a desired orientation of the user interface 170 that is presented on the display 150. For example, if the wearable electronic device 100 is in a first orientation, the user interface 170 may be automatically rendered in an associated orientation. If the orientation of the wearable electronic device 100 is changed to a second orientation that is different from the first orientation, the processor may be configured to render the user interface 170 in a second orientation.

Similarly, if input from the sensor 110 and/or the microphone 120 indicates that the display 150 of the wearable electronic device 100 is obscured or not in a line of sight of an individual wearing the wearable electronic device 100, the processor 130 may cause the display 150 to shut down. In other embodiments, when it is determined that the wearable electronic device 100 is obscured or not in a line of sight of the individual wearing the wearable electronic device 100, the processor 130 may cause the wearable electronic device 100 to enter a reduced power state. In certain embodiments, when the wearable electronic device 100 is no longer obscured, or when the wearable electronic device 100 is within a line of sight, the processor 130 may cause the wearable electronic device 100 to enter a full power state. In such embodiments, the wearable electronic device 100 may not enter and exit the low power state unless the wearable electronic device 100 is obscured or not within a line of sight for a predetermined period of time. Likewise, the wearable electronic device 100 may not exit the reduced power state until user input is received and/or the wearable electronic device 100 is not obscured or is within a line of sight for a predetermined amount of time.

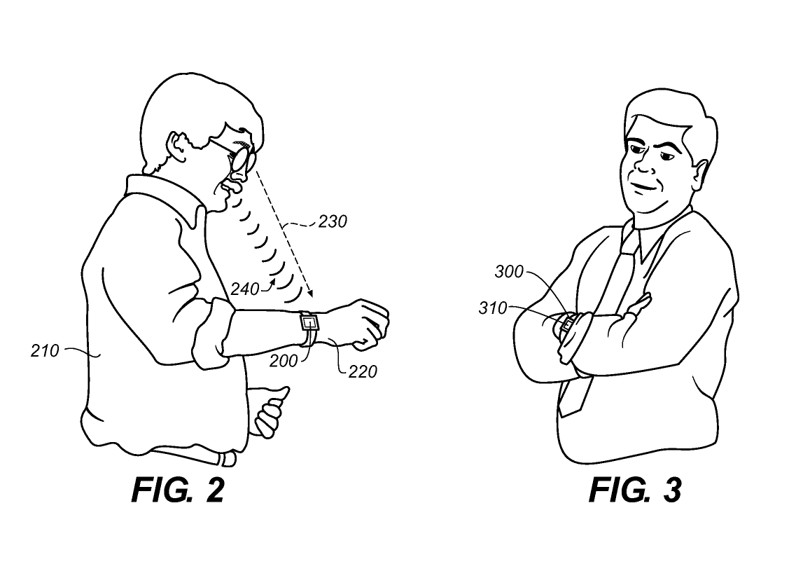

FIG. 2 illustrates a wearable electronic device 200 being worn by an individual 210 according to one or more embodiments of the present disclosure. In certain embodiments, the wearable electronic device 200 shown in FIG. 2 may be the wearable electronic device 100 shown and described above with respect of FIG. 1. As shown in FIG. 2, the wearable electronic device 200 may be worn on an arm of the individual 210. As described above, when the wearable electronic device 200 is worn on the arm of the individual 210, one or more sensors in the wearable electronic device 200 may be configured to determine a location and orientation of the wearable electronic device 200. For example, as shown in FIG. 2, the wearable electronic device 200 is located on a back side of a wrist 220 of the individual 210. Based on the determined orientation of the wearable electronic device 200, a user interface (e.g., user interface 150 of FIG. 1) is rendered on a display (e.g., display 140 of FIG. 1) of the wearable electronic device 200 in an associated orientation.

As discussed above, one or more sensors (e.g., sensor 110 of FIG. 1) may be configured to determine the orientation and/or location of the wearable electronic device 200. For example, the sensor may be configured to determine whether the wearable electronic device is being worn on a right arm or a left arm of the individual 210. Additionally, the sensor may be configured to determine a distance between the wearable electronic device and a head of the individual 210. As also discussed above, the sensor may be configured to determine whether the display is in a sight line 230 of the individual 210. In such embodiments, if the wearable electronic device is not in a sight line 230 of the individual 210, the wearable electronic device enters a low power state. In other embodiments, the line of sight 230 determination may also be used to determine an orientation or placement of the wearable electronic device 200. This information may then be used by a processor (e.g., processor 130 of FIG. 1) to determine an orientation of the displayed user interface.

One or more embodiments also provide that the wearable electronic device 200 may also include a microphone (e.g., microphone 120 of FIG. 1). In such embodiments, the microphone may be configured to detect and recognize a voice 240 of the individual 210. When received, the voice 240 information may be used to determine a location of the wearable electronic device with respect to the individual 210 and the orientation of the wearable electronic device 200. Based on this information, the processor of the wearable electronic device 200 may be configured to determine an orientation at which the user interface is to be rendered on the display.

FIG. 3 illustrates a wearable electronic device 300 in which a user interface 310 of the wearable electronic device 300 is partially occluded according to one or more embodiments of the present disclosure. In certain embodiments, the wearable electronic device 300 shown in FIG. 3 is similar to the wearable electronic device 100 shown and described above with respect to FIG. 1. As discussed above, one or more sensors (e.g., sensor 110 of FIG. 1) may receive input that indicates that a display (e.g., display 140 of FIG. 1) is at least partially occluded. In such embodiments, a processor (e.g., processor 130 of FIG. 1) may cause the wearable electronic device 300 to enter a standby phase or a low power state. In certain embodiments, when one or more sensors determine that the wearable electronic device is no longer partially or completely occluded, the wearable electronic device may enter a full power state.

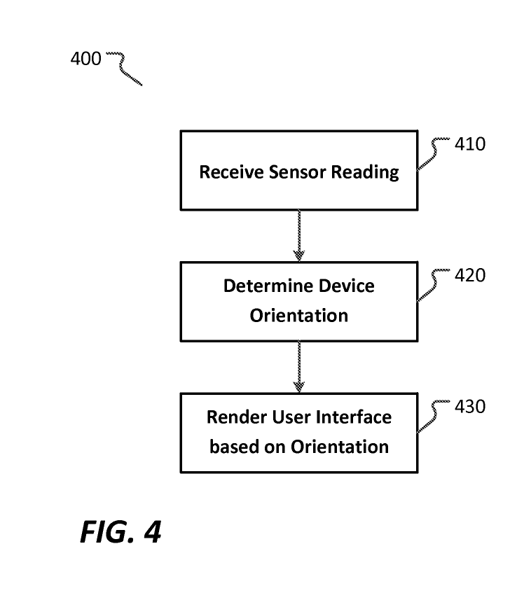

FIG. 4 illustrates a method 400 for presenting a user interface on a display of a wearable electronic device based on a determined orientation of the wearable electronic device according to one or more embodiments of the present disclosure. The method 400 described below may be used with the wearable electronic device 100 shown and described above with respect to FIG. 1.

The method 400 begins when a sensor reading is received 410. According to one or more embodiments, the sensor reading may be received from a sensor, such as, for example, sensor 110 (FIG. 1) contained within the wearable electronic device. As discussed above, the sensor may be a biometric sensor, a light sensor, an image sensor, a pressure sensor and the like. Although specific sensors are mentioned, it is contemplated that any number of sensors may be used. Additionally, it is contemplated that various combinations of sensors may be used to receive the input. For example, input may be received simultaneously or substantially simultaneously from a light sensor and a pressure sensor.

Once the input is received, flow proceeds to operation 420 in which the orientation of the wearable electronic device is determined. In certain embodiments, the orientation may include the location of the wearable electronic device on the individual wearing the wearable electronic device (e.g., on the left wrist of the individual) as well as the orientation of the wearable electronic device with respect to the individual wearing the wearable electronic device. For example, if the individual is wearing the wearable electronic device on a wrist, a determination is made as to whether the display is located on the back of the wrist or the front of the wrist. Although specific orientations are mentioned, it is contemplated that the display may be located at another location such as, for example, on a side of the wrist.

When the orientation and location of the wearable electronic device is determined, flow proceeds to operation 430 in which a user interface is rendered on the display in a determined orientation. In certain embodiments, the user interface is rendered in an orientation that is associated with a preferred orientation of the user interface with respect to the location and orientation of the wearable electronic device. For example, regardless of the orientation of the wearable electronic device, the user interface may be displayed in an orientation that is viewed by the individual as “right side up.”

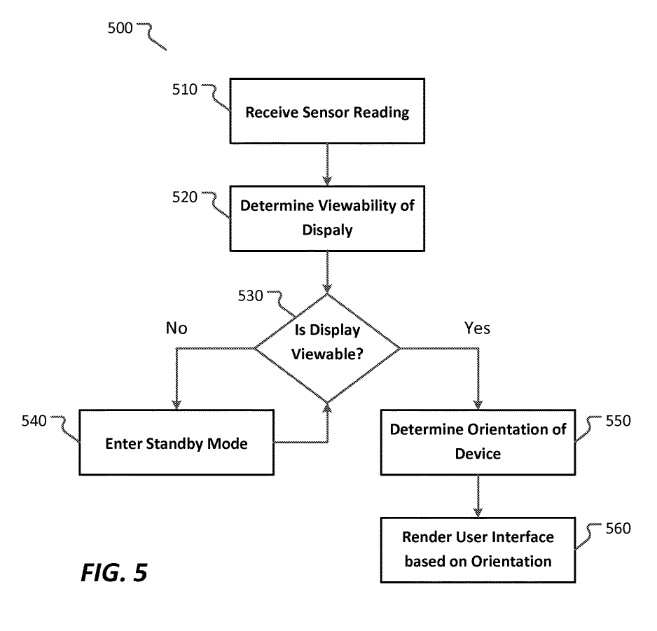

FIG. 5 illustrates a method 500 for presenting a user interface on a display of wearable electronic device according to one or more embodiments of the present disclosure. The method 500 described below may be used with a wearable electronic device 100 shown and described above with respect to FIG. 1.

The method 500 begins when a sensor reading is received 510. According to one or more embodiments, the sensor reading may be received from a sensor, such as, for example, sensor 110 (FIG. 1) contained in the wearable electronic device. As discussed above, the sensor may be a biometric sensor, a light sensor, an image sensor, a pressure sensor and the like. Additionally, the sensor reading may be received from another input device such as, for example a microphone. Although specific sensors are mentioned, it is contemplated that any number of sensors may be used. Additionally, it is contemplated that various combinations of sensors may be used to receive the input.

Flow then proceeds to operation 520 in which the viewability of a display of the wearable electronic device is determined. In certain embodiments, the viewability is determined based on the received sensor readings. For example, the received sensor readings may indicate that the display of the wearable electronic device is in an orientation in which the display is not currently visible to an individual wearing the wearable electronic device. Likewise, the sensor reading may determine that the display of the wearable electronic device is occluded or partially occluded from view (e.g., due to a piece of clothing covering the display of the wearable electronic device.

In operation 530 a determination is made as to whether the display is viewable. As discussed above, this determination may be made based on one or more sensor readings. If it is determined that the display is not viewable, flow proceeds to operation 530 and the wearable electronic device enters a standby mode or a low power state. In certain embodiments, when the wearable electronic device enters a low power state some functionality of the wearable electronic device is reduced. As such, the wearable electronic device consumes less power. In certain embodiments, once the wearable electronic device enters the low power state, flow proceeds back to operation 530 and it is again determined whether the display of the wearable electronic device is viewable. If it is determined that the display of the wearable electronic device is still not viewable, the wearable electronic device remains in the standby mode.

However, if it is determined in operation 530 that the display of the wearable electronic device is viewable, flow proceeds to operation 550 and an orientation of the wearable electronic device is determined. In certain embodiments, the orientation may include information corresponding to where the device is located on an individual wearing the wearable electronic device as well as the orientation of the wearable electronic device with respect to the individual wearing the wearable electronic device. For example, if the individual is wearing the wearable electronic device on a wrist, a determination is made as to whether the wearable electronic device is located on the back of the wrist or the front of the wrist.

When the orientation of the wearable electronic device is determined, flow proceeds to operation 560 and a user interface is rendered on the display in a determined orientation. In certain embodiments, the user interface is rendered in an orientation that is associated with a preferred orientation of the user interface with respect to the determined location or orientation of the wearable electronic device. That is, regardless of the orientation of the wearable electronic device, the user interface is rendered on the display in an orientation that is “right side up” with respect to the individual wearing the wearable electronic device.

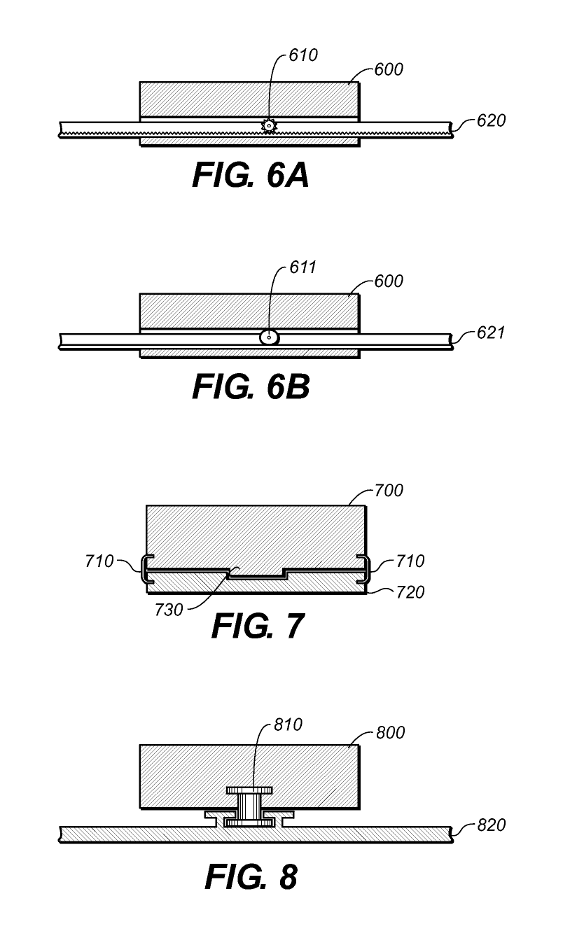

FIGS. 6A-6B illustrate an exemplary wearable electronic device 600 according to one or more embodiments of the present disclosure. In certain embodiments the wearable electronic device 600 may be similar to the wearable electronic device 100 shown and described above with reference to FIG. 1. In addition to the functionality described above with reference to FIG. 1, the wearable electronic device 600 may also include a mechanism that enables the wearable electronic device 600 to automatically move along an attached band.

Specifically, FIG. 6A illustrates a wearable electronic device 600 that includes a gear mechanism 610 that is coupled to and powered by a motor (not shown). Although only one gear mechanism is shown, it is contemplated that the wearable electronic device has multiple gear mechanisms. In embodiments, the gear mechanism 610 may be configured to mate with a band 620 that is removably or slideably coupled to the wearable electronic device 600. For example, as shown in FIG. 6A, the band 620 may be inserted into a proximal end of the wearable electronic device 600 and exit from a distal end of the wearable electronic device 600. The band 620 may be configured to slide within or through each end of the wearable electronic device 600. In certain embodiments, the gear mechanism 610 and/or the band 620 may have grooves or “teeth” that enable the wearable electronic device 600 to move along the band 620 as the gear mechanism is turned.

Likewise, FIG. 6B illustrates a wearable electronic device 600 that includes a gear mechanism 611 that is coupled to and powered by a motor (not shown). Although only one gear mechanism 611 is shown, it is contemplated that the wearable electronic device 600 includes multiple gear mechanisms. The gear mechanism 611 may be configured to frictionally mate with a band 621 that is slideably coupled to the wearable electronic device 600. In certain embodiments, the gear mechanism 611 may have a smooth outer edge that creates a frictional force with the band 621. As a result, when the gear mechanism 611 turns, the wearable electronic device 600 may move along the band 621.

FIG. 7 illustrates a wearable electronic device 700 that includes one or more retention features 710 according to one or more embodiments of the present disclosure. The retention features 710 may be configured to hold the wearable electronic device 700 to a wearable band 720 at a determined location. The retention features 710 may be used in combination with the wearable electronic device described above with reference to FIGS. 6A and 6B. For example, once the wearable electronic device 700 has been moved to a particular location along a band 720, the retention features 710 may be configured to engage with the band 720 to hold the wearable electronic device 700 in place. Additionally, when the wearable electronic device 700 is going to move along the band 720, the retention features 710 may be configured to automatically disengage from the band 720. It is also contemplated that the wearable electronic device 700 may have a mating mechanism 730 disposed thereon. The mating mechanism may be configured to mate with a receiving portion on the band 720.

FIG. 8 illustrates a wearable electronic device 800 that is configured to rotate about an axis according to one or more embodiments of the present disclosure. In certain embodiments, the wearable electronic device may have similar components and functionality as the wearable electronic device 100 shown and described above with reference to FIG. 1. As shown in FIG. 8, the wearable electronic device 800 may be rotatably coupled to a wearable band 820. In embodiments, the wearable electronic device 800 may include an electronic pivot mechanism 810 that causes the wearable electronic device 800 to automatically rotate about an axis with respect to a band 820. In such embodiments, the wearable electronic device 800 may rotate about an axis based on one or more sensor readings. It is also contemplated that the wearable electronic device 800 may rotate about an axis based on received user input.

For example, if the wearable electronic device 800 has a microphone that points away from an individual wearing the wearable electronic device 800, the wearable electronic device 800 could rotate (either automatically or based on a received command) so that the microphone would be facing toward the individual wearing the wearable electronic device 800. In embodiments, as the wearable electronic device rotates, an orientation of a user interface, such as user interface 170 (FIG. 1) would also rotate accordingly.

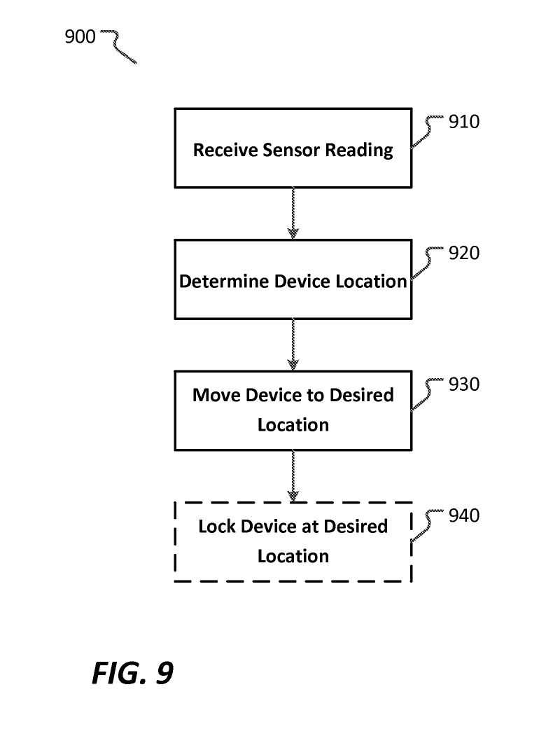

FIG. 9 illustrates a method 900 for changing a position of a wearable electronic device along a band according to one or more embodiments of the present disclosure. In certain embodiments, the method 900 may be used with a wearable electronic device 100 shown and described above with reference to FIG. 1. Additionally, the method 900 may be used with the wearable electronic devices shown and described above in conjunction with FIGS. 6A-8. Method 900 begins when a sensor reading is received 910 by a sensor coupled to the wearable electronic device. As discussed above, the sensor may be a biometric sensor, a light sensor, an image sensor, a pressure sensor and the like.

Once the sensor reading is received, flow proceeds to operation 920 in which the sensor reading is used to determine a location and orientation of the wearable electronic device. In certain embodiments, the location determination may be a location of the wearable electronic device with respect to an individual wearing the wearable electronic device. For example the location determination may be a determined location on a wrist (e.g., top of the wrist, bottom of the wrist, side of the wrist etc.) of an individual wearing the wearable electronic device.

When the location is determined, flow proceeds to operation 930 and the wearable electronic device is automatically moved to a desired location. In certain embodiments, the desired location is set by an individual wearing the wearable electronic device. In another embodiment the desired location is learned over time based on where the individual wears the wearable electronic device. For example, if an individual typically wears the wearable electronic device on the back of the wrist, the wearable electronic device learns that this location is the desired location. Accordingly, when the wearable electronic device senses it is no longer in the desired location, the wearable electronic device will move itself to that location. As discussed above, the wearable electronic device may have a small motor and gear mechanism that interfaces with the wearable band and causes the electronic device to move along the wearable band such as shown and described above with reference to FIGS. 6A and 6B. In another embodiment, the wearable electronic device may be moved by magnetizing a various areas on the wearable band. Thus, if the band moves around the wrist of the individual wearing the wearable electronic device, the magnetic force may cause the wearable electronic device to move from a first location to a second, preferred location.

Once the wearable electronic device has been moved to the desired location, flow (optionally) proceeds to operation 940 and the wearable electronic is locked in the desired location. In embodiments, a locking mechanism may be used to lock the wearable electronic device in the desired location. It is contemplated that the locking mechanism used is the locking mechanisms shown and described with reference to FIG. 7 above. Although the wearable electronic device is locked in place, it is contemplated that the locking mechanism may be configured to release the wearable electronic device when it is determined that the wearable electronic device is to be moved to a different location.

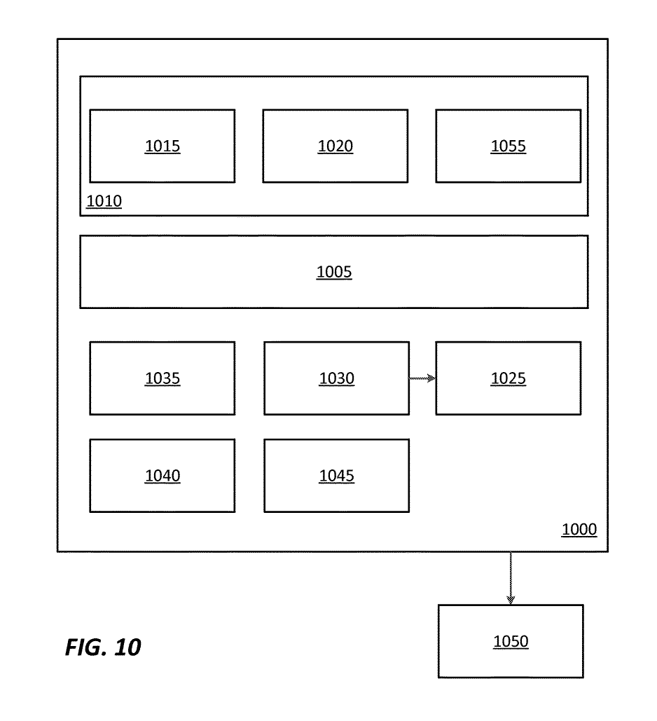

FIG. 10 is a block diagram illustrating exemplary components, such as, for example, hardware components of a wearable electronic device 1000 according to one or more embodiments of the present disclosure. In certain embodiments, the wearable electronic device 1000 may be similar to wearable electronic device 100 described above with respect to FIG. 1. In a basic configuration, the wearable electronic device 1000 may include at least one processor 1005 and an associated system memory 1010. The system memory 1010 may comprise, but is not limited to, volatile storage such as random access memory, non-volatile storage such as read-only memory, flash memory, or any combination thereof. The system memory 1010 may have an operating system 1015 stored thereon and one or more program modules 1020 suitable for running software applications 1055. The operating system 1015 may be configured to control the wearable electronic device 1000 and/or one or more software applications 1055 being executed by the operating system 1015. Additionally, one or more embodiments of the present disclosure provide for a graphics library, additional operating systems, or any other application program. The wearable electronic device 1000 may have additional features or functionality than those expressly described herein. For example, the wearable electronic device 1000 may also include additional data storage devices, removable and non-removable, such as, for example, magnetic disks, optical disks, or tape. Exemplary storage devices are illustrated in FIG. 10 by removable storage device 1025 and a non-removable storage device 1030.

In certain embodiments, various program modules and data files may be stored in the system memory 1010. The program modules 1020 and the processor 1005 may perform processes that include one or more of the operations of methods 400, 500, and 900 illustrated in FIGS. 4, 5, and 9.

It is also contemplated that one or more embodiments of the present disclosure may be practiced in an electrical circuit. The electrical circuit may comprise discrete electronic elements, packaged or integrated electronic chips containing logic gates, a circuit utilizing a microprocessor, or on a single chip containing electronic elements or microprocessors. For example, one or more embodiments of the present disclosure may be practiced using a system-on-a-chip (SOC) onto which one or more of the components illustrated in FIG. 10 are integrated. Such a device may include one or more processing units, graphics units, communications units, system virtualization units and various application functionality all of which may be integrated onto the chip substrate. The functionality described herein may be operated via application-specific logic integrated with other components of the wearable electronic device 1000 on the single integrated circuit.

One or more embodiments of the present disclosure may also be implemented using technologies that are capable of performing logical operations (e.g., AND, OR, and NOT) as well as mechanical, optical, fluidic, and quantum technologies. In addition, embodiments of the present disclosure may be implemented as, with, or in conjunction with a general purpose computer or in any other circuits or systems.

As also shown in FIG. 10, the wearable electronic device 1000 may include one or more input devices 1035. The input devices 1035 may include a keyboard, a mouse, a pen or stylus, a sound input device, a touch input device, and the like. The wearable electronic device 1000 may also include one or more output devices 1040. The output devices 1040 may include a display, one or more speakers, a printer, and the like. The wearable electronic device 1000 may also include one or more communication connections 1045 that facilitate communications with additional computing devices 1050. Such communication connections 1045 may include a RF transmitter, a receiver, and/or transceiver circuitry, universal serial bus (USB) communications, parallel ports and/or serial ports.

As used herein, the term computer readable media may include computer storage media. Computer storage media may include volatile and nonvolatile media and/or removable and non-removable media implemented in any method or technology for the storage of information. Examples include computer-readable instructions, data structures, or program modules. The system memory 1010, the removable storage device 1025, and the non-removable storage device 1030 are all examples of computer storage media. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the wearable electronic device 100. Any such computer storage media may be part of the wearable electronic device 100. Computer storage media does not include a carrier wave or other propagated or modulated data signal.

Communication media may be embodied by computer-readable instructions, data structures, program modules, or other data in a modulated data signal, such as, for example, a carrier wave, transport mechanism, and other forms of information delivery media. The term “modulated data signal” may describe a signal that has one or more characteristics set or changed in such a manner as to encode information in the signal. Additionally, communication media may include wired media such as a wired network or direct-wired connection, and wireless media such as acoustic, radio frequency (RF), infrared, and such forms of wireless media.

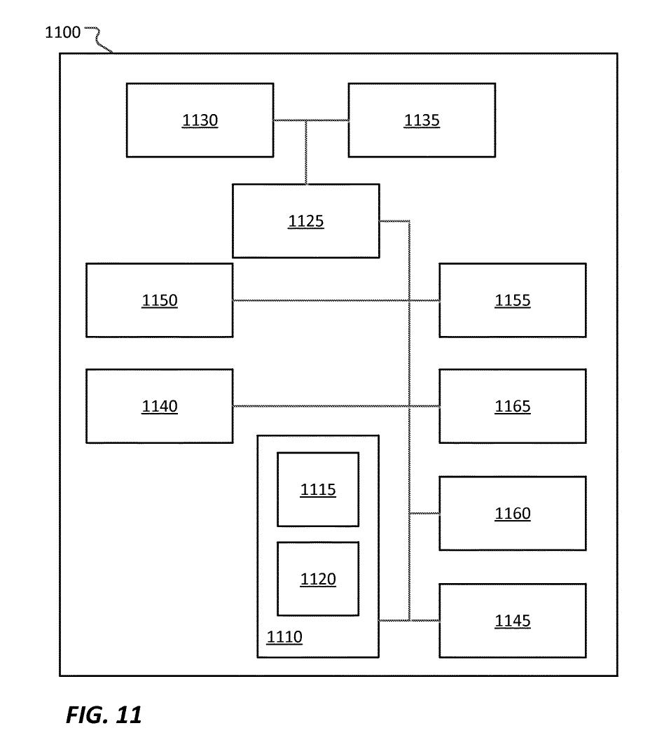

FIG. 11 illustrates another exemplary electronic device 1100 according to one or more embodiments of the present disclosure. FIG. 11 is a block diagram illustrating the architecture of a wearable electronic device such as wearable electronic device 100 (FIG. 1). For example, the wearable electronic device 1100 can incorporate a system or architecture 1105 to implement one or more embodiments disclosed herein.

In certain embodiments, the system 1105 is implemented as a an electronic device that may execute one or more applications or programs. These applications or programs include browser applications, e-mail applications, calendaring applications, contact manager applications, messaging applications, games, media player applications and the like. In some embodiments, the system 1102 is an integrated computing device that has multiple functionalities.

One or more embodiments provide that application programs may be loaded into a memory 1110 and may be executed by, or in association with, the operating system 1115. Additional exemplary application programs may include phone dialer programs, e-mail programs, personal information management (PIM) programs, word processing programs, spreadsheet programs, Internet browser programs, messaging programs, and the like. The system 1105 also includes a non-volatile storage area 1120 within the memory 1110. The non-volatile storage area 1120 may be used to store persistent information (e.g., information that is saved when the system 1105 is powered down). In certain embodiments, the application programs may use and store information in the non-volatile storage area 1120. A synchronization application or module (not shown) may also be included with the system 1105. In certain embodiments, the synchronization system is programmed to interact with a corresponding synchronization application resident on a host computer or other such device to keep the information stored in the non-volatile storage area 1120 synchronized with corresponding information stored at the host computer or other such device. Although specific applications are mentioned, it is contemplated that other applications may be loaded into the memory 1110 and executed on the electronic device 1100.

In embodiments, the system 1105 includes a power supply 1125. The power supply 1125 may be a battery, solar cell, and the like. The power supply 1125 may also include an external power source, such as an AC adapter, USB port, or other such connector that supplements or recharges the batteries. The system 1105 may also include a radio 1130 that performs the function of transmitting and receiving radio frequency communications. Such communications may be between the system 1105 and a communication carrier or service provider. Transmissions to and from the radio 1130 may be under the control of the operating system 1115. Additionally, communications received by the radio 1130 may be disseminated to the application programs disclosed herein the operating system 1115. Likewise, communications from the application programs may be disseminated to the radio 1130 as needed by the operating system 1115.

One or more embodiments also provide that the electronic device 1000 may include a visual indicator 1135, a keypad 1160 and a display 1165. In embodiments, the keypad may be a physical keypad or a virtual keypad generated on a touch screen display 1165. As discussed above, the display 1165 may be used to render a graphical user interface.

The visual indicator 1135 may be used to provide visual notifications to a user of the electronic device 1000. The electronic device may also include an audio interface 1140 that may be used for producing audible notifications. In certain embodiments, the visual indicator 1135 is a light emitting diode (LED) and the audio interface 1140 is a speaker. In certain embodiments, the audio interface may be configured to receive audio input. In embodiments, these devices may be coupled to the power supply 1125 so that when activated, they remain on for a duration dictated by a notification mechanism even though the processor 1145 and other components might shut down for conserving battery power. In embodiments, visual indicator may be programmed to remain on until an action is taken to indicate the status of the device.

The audio interface 1140 may also be used to provide and receive audible signals from a user of the electronic device 1000. For example, a microphone may be used to receive audible input. In accordance with embodiments of the present disclosure, the microphone may also serve as an audio sensor to facilitate control of notifications. The system 1105 may further include a video interface 1150 that enables an operation of an on-board camera 1155 to record still images, video, and the like.

In one or more embodiments, data and information generated or captured by the electronic device 1100 may be stored locally. Additionally or alternatively, the data may be stored on any number of storage media that may be accessed by the electronic device 1100 using the radio 1130, a wired connection or a wireless connection between the electronic device 1100 and a remote computing device. Additionally, data and information may be readily transferred between computing devices for storage and use according to various data and information transfer and storage mediums including electronic mail and collaborative data and information sharing systems.

Embodiments of the present disclosure are described above with reference to block diagrams and operational illustrations of methods and the like. The operations described may occur out of the order as shown in any of the figures. Additionally, one or more operations may be removed or executed substantially concurrently. For example, two blocks shown in succession may be executed substantially concurrently. Additionally, the blocks may be executed in the reverse order.

The description and illustration of one or more embodiments provided in this disclosure are not intended to limit or restrict the scope of the present disclosure as claimed. The embodiments, examples, and details provided in this disclosure are considered sufficient to convey possession and enable others to make and use the best mode of the claimed embodiments. Additionally, the claimed embodiments should not be construed as being limited to any embodiment, example, or detail provided above. Regardless of whether shown and described in combination or separately, the various features, including structural features and methodological features, are intended to be selectively included or omitted to produce an embodiment with a particular set of features. Having been provided with the description and illustration of the present application, one skilled in the art may envision variations, modifications, and alternate embodiments falling within the spirit of the broader aspects of the embodiments described herein that do not depart from the broader scope of the claimed embodiments.

We claim:

1. A method for presenting a user interface on a wearable electronic device, the method comprising:
receiving input from at least one sensor coupled to the wearable electronic device;
determining, based on the input from the at least one sensor, an orientation of the wearable electronic device with respect to an object to which the wearable electronic device is attached; and
displaying a user interface on a display of the wearable electronic device, wherein the user interface is displayed in a first orientation based, at least in part, on the determined orientation of the wearable electronic device.

2. The method of claim 1, wherein the sensor is an accelerometer.

3. The method of claim 1, wherein the sensor is a biometric sensor configured to detect a pulse associated with the object to which the wearable electronic device is attached.

4. The method of claim 1, wherein the sensor is configured to determine whether the display of the wearable electronic device is in a field of view of a portion of the object to which the wearable electronic device is attached.

5. The method of claim 1, further comprising receiving additional input, wherein the orientation of the user interface is based, at least in part, on the additional input.

6. The method of claim 5, wherein the additional input is touch input on the display of the wearable electronic device.

7. The method of claim 1, wherein the sensor is a pressure sensor.

8. The method of claim 1, further comprising receiving input from a voice input mechanism, wherein the input from the voice input mechanism is used, in conjunction with the input from the at least one sensor, to determine the orientation of the wearable electronic device.

9. A method for presenting a user interface on a wearable electronic device, the method comprising:
receiving input from at least one sensor coupled to the wearable electronic device;
determining, based on the input from the at least one sensor, whether a display of the wearable electronic device is in a field of view of a wearer of the wearable electronic device;
when it is determined that the display of the wearable electronic device is not in a field of view of the wearer of the wearable electronic device, causing the display to enter a standby mode; and
when it is determined that the display of the wearable electronic device is in a field of the view of the wearer of the wearable electronic device:
determining, based on the input from the at least one sensor, an orientation of the wearable electronic device; and
displaying a user interface on the display of the wearable electronic device, wherein the user interface is displayed in a first orientation based, at least in part, on the determined orientation of the wearable electronic device.

10. The method of claim 9, wherein determining whether a display of the wearable electronic device is in a field of view of a wearer of the wearable electronic device comprises determining whether the display is at least partially occluded.

11. The method of claim 9, further comprising:
detecting a reorientation of the wearable electronic device; and
displaying the user interface in a second orientation based, at least in part, on the detected reorientation of the wearable electronic device, wherein the first orientation is different from the second orientation.

12. The method of claim 9, wherein the at least one sensor is a light sensor.

13. The method of claim 9, wherein the at least one sensor is a microphone.

14. The method of claim 9, wherein the at least one sensor is a proximity sensor.

15. The method of claim 9, wherein the at least one sensor is a camera.

16. A device comprising:
at least one sensor;
at least one processor; and
a memory coupled to the at least one processor, the memory for storing instructions which, when executed by the at least one processor performs a method for presenting a user interface on a wearable electronic device, the method comprising:
receiving input from the at least one sensor;
determining, based on the input from the at least one sensor, whether a display of the wearable electronic device is in a field of view of a wearer of the wearable electronic device;
when it is determined that the display of the wearable electronic device is not in a field of view of the wearer of the wearable electronic device, causing the display to enter a standby mode; and
when it is determined that the display of the wearable electronic device is in a field of the view of the wearer of the wearable electronic device:
determining, based on the input from the at least one sensor, an orientation of the wearable electronic device; and
displaying a user interface on the display of the wearable electronic device, wherein the user interface is displayed in a first orientation based, at least in part, on the determined orientation of the wearable electronic device.

17. The device of claim 16, wherein determining whether a display of the wearable electronic device is in a field of view of a wearer of the wearable electronic device comprises determining whether the display is at least partially occluded.

18. The device of claim 16, further comprising instructions for:
detecting a reorientation of the wearable electronic device; and
displaying the user interface in a second orientation based, at least in part, on the detected reorientation of the wearable electronic device, wherein the first orientation is different from the second orientation.

19. The device of claim 16, wherein the at least one sensor is a light sensor.

20. The device of claim 16, wherein the at least one sensor is a microphone.
